(19) United States
(12) Patent Application Publication
(10) Pub. No.: US 2005/0231752 A1
(43) Pub. Date: Oct. 20, 2005

(54) Image data transfer system and method

(75) Inventor: Kari Sainio, Vantaa (FI)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/826,246

(22) Filed: Apr. 16, 2004

(51) Int. Cl. G06F 15/00

(52) U.S. Cl. 358/1.15

(57) ABSTRACT

A method, system, and program product is disclosed for transferring image data between a sending device and one or more receiving devices. A communication session can be established between the sending device and receiving device(s). The sending device can send a notification of availability of image data on a common transmission channel and at least a portion of the image data can be transferred to the receiving device(s) on one or more data channels. A dedicated data channel can be opened up for each receiving device.

### BACKGROUND OF THE INVENTION

The present invention relates generally to the field of data transfer, and particularly to systems and methods of transferring image data between a sending device and one or more receiving devices.

The use of digitally stored images and the sharing of such images among different users is becoming increasingly popular. An image may be uploaded to a server by a user, and then be downloaded by one or more other users for viewing. For example, it is becoming popular to share personal digital photos with others by uploading them to a server for future downloading by other users. Moreover, with the introduction of the so-called third generation of mobile telephone networks, and its third-generation wireless terminals, of which many have an integrated digital camera and a color display, the sharing of images among users and uploading/downloading of images to/from server is expected to increase dramatically.

Until recently, an image has been regarded as represented by non-real-time data. However, the increasing desire to share images between and among different users, and the introduction of wireless terminals with color displays and integrated digital cameras, is changing this. It is now appreciated that storing, sharing and retrieval of images can be made in a more sophisticated way. Techniques have been developed for the exchange of image-related data within a client/server relationship. This exchange of image data provides mechanisms for locating and retrieving parts of a digitally stored image from a server to a client. The client may then display and store the retrieved part. This also provides the possibility of browsing images (e.g., to successively locate and retrieve different parts of an image). Such browsing is suitable for viewing a large image with a small display of a wireless terminal without compromising the resolution of the image. The image data can then be regarded as being streamed as real-time data to the recipient. Since it is of importance that the browsing can be performed in a smooth and continuous manner. It can at the same time be regarded as an interactive way of viewing an image.

An example of a protocol designed for the exchange of image-related data within a client/server relationship is JPEG 2000 Internet Protocol (JPIP). JPIP is a protocol designed to provide access and transmission of JPEG 2000 coded data and related metadata in a networked environment. It consists of a structured series of interactions between a client and a server, by means of which image file metadata, structure and partial or whole image codestreams may be exchanged in an efficient manner. JPIP defines the semantics and the values to be exchanged using a variety of existing network transport protocols, including TCP, UDP and HTTP. JPIP is to be used by applications for image browsing, image surface, image or metadata retrieval, and image uploading. For more information on JPIP, reference may be made to part 9 of the JPEG 2000 standard prepared by ISO/IEC and ITU-T, currently available on www.jpeg.org.

### SUMMARY OF THE INVENTION

One embodiment of the invention relates to a method of transferring image data. The method includes establishing a communication session between a sending device and one or more receiving devices, opening a common channel for transmission by the sending device of a notification of availability of image data, and opening one or more data channels for transmission of at least a portion of the image data to the receiving devices, each data channel being dedicated to one of the receiving devices. The step of establishing a communication session may include establishing a session using Session Initiation Protocol (SIP). The step of establishing a communication session may also include indicating use of Blocks Extensible Exchange Protocol (BEEP) to exchange image data in JPEG 2000 Interactive Protocol (JPIP). The common channel and the data channels may be BEEP channels. The sending device may include an image data server. In one embodiment, at least one of the sending device and the receiving devices is a wireless device.

In another embodiment, a system for transferring image data includes a sending device adapted to establishing a communication session with one or more receiving devices, and an image data server adapted to respond to requests for image data from the receiving devices. At least one of the sending device and the image data server is adapted to open one or more data channels for transmission of image data to the receiving devices. Each data channel is dedicated to one of the receiving devices.

### BRIEF DESCRIPTION OF THE DRAWINGS

FIG. 1 is a schematic illustration of an arrangement for transferring image data according to an embodiment of the invention;

FIG. 2 is a schematic illustration of an arrangement for transferring image data according to another embodiment of the invention;

FIG. 3 is a schematic illustration of a communication session using the Session Initiation Protocol (SIP) for use in the arrangement of FIG. 1; and

FIG. 4 is a schematic illustration of a Blocks Extensible Exchange Protocol (BEEP) session within the SIP session of FIG. 3 for use in the arrangement of FIG. 1.

### DETAILED DESCRIPTION OF THE PREFERRED EMBODIMENTS

Embodiments of the present invention allow a sending device to share an image with one or more receiving devices. Each receiving device receives image data according to parameters specified by the receiving device. Thus, a receiving device capable of displaying a low-resolution image may request data corresponding to the low resolution, thereby requiring less data to be transferred than for a high-resolution image.

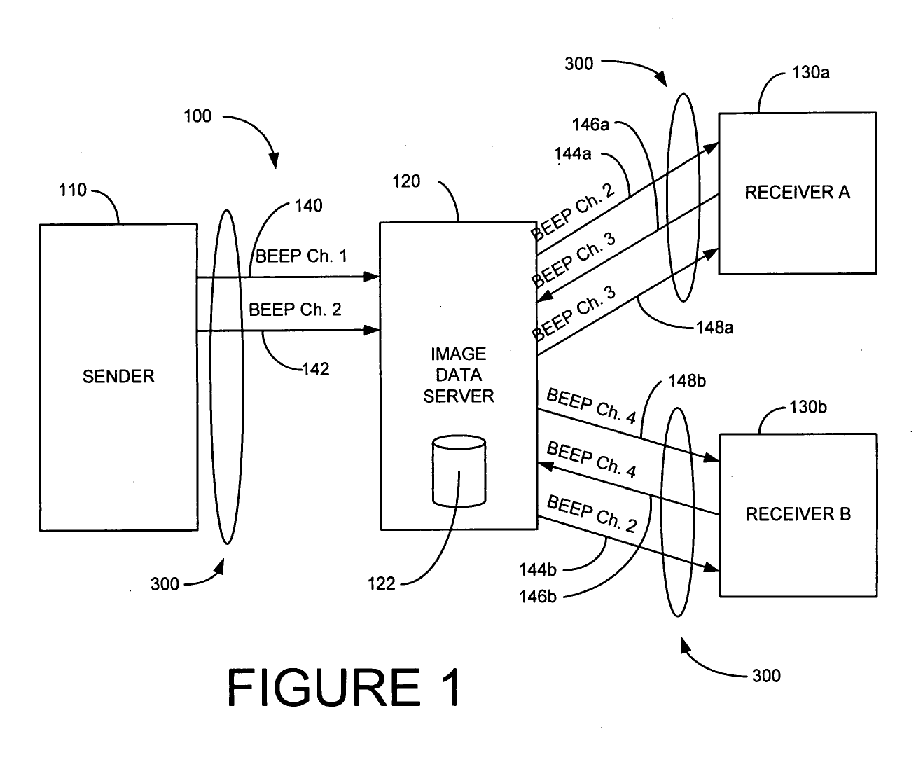

Referring to FIG. 1, an arrangement according to an embodiment of the invention is illustrated. In this arrangement 100, a sending device 110, which may be any device capable of communication with other devices, is provided. For example, the sending device 110 may be wireless device such as a cellular telephone.

An image data server 120 is provided access to image data to one or more receiving devices, such as receiving devices 130a, 130b. The image data server 120 is provided with a storage capability, such as a database 122, for storing image data. The image data server 120 may be a standard server, such as an Apache server, or others.

As with the sending device 110, the receiving devices 130a, 130b may also be any of a number of devices capable of communicating. For example, the receiving devices 130a, 130b may be wireless devices, such as cellular telephones, or desktop computers.

Referring again to FIG. 1, in practice, a user operating the sending device 110 may wish to share image data with one or more users having receiving devices 130a, 130b. The sending device 110 may be equipped with a digital camera, for example, and the user may wish to share a digital photograph with other users.

When a user elects to share image data, the sending device 110 establishes a communication session 300 between the sending device 110 and one or more receiving devices 130a, 130b. In a particular embodiment, the communication session is a Transfer Control Protocol (TCP) session using the Session Initiation Protocol (SIP) as an upper layer protocol.

SIP is an application-layer signalling protocol defined by the Internet Engineering Task Force (IETF). SIP can establish, modify and terminate multimedia sessions or calls with one or more participants. The sessions can include IP-based videoconferences, Internet audio calls, shared whiteboard, gaming sessions, multimedia distribution, etc. The entities involved in a SIP session may be referred to as client user agent and server user agent. Within the context of SIP, use is often made of a protocol known as the Session Description Protocol (SDP). SDP is a text-based format used for describing media parameters and data carried by the SIP. It can also be used for specifying client capabilities. Further details concerning SIP and SDP are sufficiently well known to those skilled in the art and do not require further description.

One example of a use of SIP in an image data transfer environment is described in international patent application PCT/IB03/06134, which is hereby incorporated by reference in its entirety.

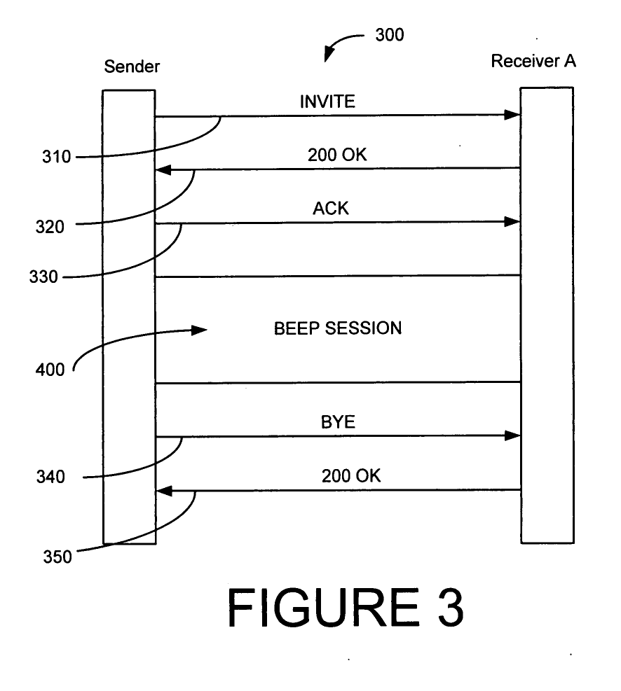

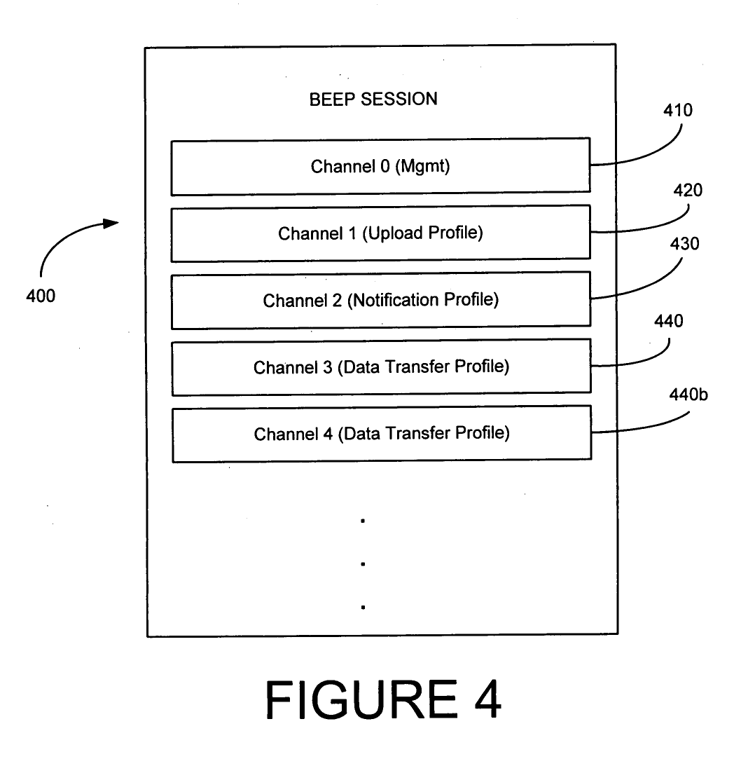

FIG. 3 is a schematic illustration of an exemplary SIP session 300, as may be established between the sending device 110 and one or more receiving devices 130a, 130b. To establish the session, the sending device 110 may transmit a request for a session to each receiving device. For purposes of clarity, FIG. 3 illustrates an SIP session between a sending device and a single receiving device. It will be understood by those skilled in the art, along with the description of a BEEP session below with reference to FIG. 4, that a similar session may be established with other receiving devices. SIP supports several request methods, including INVITE (invite into a session), OPTIONS (discover the capabilities of the receiver), BYE (terminate a call), CANCEL (terminate incomplete call requests), ACK (acknowledge a successful response) and REGISTER (register the current location of a user). In the illustrated embodiment of FIG. 3, the sending device transmits an INVITE request 310 to each receiver. The INVITE request 310 may include information relating to parameters of the requested session. For example, in a particular embodiment, the INVITE request 310 may specify the use of a BEEP session to transmit JPEG 2000 image data using JPIP. Thus, the receiving device is aware that the session requested requires the receiving device to be enabled for SIP, BEEP and JPIP.

The JPEG 2000 Interactive Protocol (JPIP) is an application-level protocol, suh as HTTP or IMAP. JPIP standardizes the way clients, wishing to exchange image-related data with the host server, form request to servers as well as the responses generated by the server. JPIP is a standardized protocol that allows efficient data transfer exploiting the features of JPEG 2000.

A JPEG 2000 image can be decoded in many ways. It may be decoded in full or in part, with varying resolutions, quality levels, regions, components, etc. Considering a typical scenario where high-quality, high-resolution digital images reside in a server, clients may wish to view the images according to certain parameters, such as resolution, size, location, component, layer, and other JPEG 2000 parameters.

Referring again to FIG. 3, in response to the INVITE request 310, each receiving device sends a response to the sending device. SIP responses can be divided into six categories: 100 (status), 200 (success, such as 200 OK), 300 (redirection), 400 (improper request), 500 (unable to satisfy request) and 600 (global failure). In the illustrated embodiment, the receiving device accepts the INVITE request 310 by transmitting a 200 OK response 320.

At this point, the sending device may transmit additional requests. For example, an OPTIONS request may be transmitted to obtain information regarding the capabilities of the receiving device. In the illustrated embodiment of FIG. 3, an ACK signal 330 is transmitted to acknowledge the successful response from the receiving device. Thus, the SIP session 300 is successfully established.

In the illustrated embodiment of FIGS. 1 and 3, a Blocks Extensible Exchange Protocol (BEEP) session 400 is executed within the SIP session 300. The BEEP session 400 will be described in further detail below with reference to FIGS. 1 and 4. Once the sending device determines that the SIP session can be terminated, it transmits a BYE request 340 to each receiving device, which responds with a 200 OK response 350, thereby terminating the SIP session.

An embodiment of a BEEP session 400 is schematically illustrated in FIG. 4. BEEP is a peer-to-peer protocol. Thus, unlike HTTP, BEEP does not operate on a client/server basis. All communication in a BEEP session 400 occurs through one or more channels, such as channels 410, 420, 430, 440a, 440b. Each party requires a single TCP (or SIP) connection, within which channels are multiplexed. Each channel includes one or more profiles which determine the type of communication which can occur through that channel. A typical BEEP session includes a first channel, Channel 0 (410), for supporting a management profile used to negotiate the setup of further channels.

The use of BEEP in the image data transfer context will now be described with reference to FIGS. 1 and 4. Once the SIP session 300, and the BEEP session 400 within it, have been established, the sending device 110 sending party 110 reserves a BEEP channel, Channel 1 (420), for uploading image data to the image data server 120 (line 140). For example, the sending device 110 may be a wireless device with an integrated digital camera with images stored therein. The images are transmitted to the image data server 120 for storage in the database 122 for accessing by the receiving devices 130a, 130b. In this regard, BEEP Channel 1 (420) has a profile adapted to manage the uploading of image data, such as JPEG 2000 data. It is noted that the uploading of the image data may be accomplished outside the BEEP session 400 and outside the SIP session 300 between the sending device 110 and the receiving devices 130a, 130b. In this regard, the image data may be uploaded in a separate communication session prior to the establishment of the SIP session 300.

Once the image data has been uploaded to the image data server 120, the sending device 110 reserves another BEEP channel, Channel 2 (430), to broadcast common control signalling to where other parties can respond. BEEP Channel 2 (430) is used by the sending device 110 to notify selected receiving devices 130a, 130b that new JPEG 2000 image data has been made available on the image data server 120 (lines 140, 144a, 144b). In this regard, BEEP Channel 2 (430) is provided with a profile adapted to manage the notification.

Each receiving device 130a, 130b then reserves a different dedicated channel for streaming image data using JPIP. Thus, receiving device 130a reserves BEEP Channel 3 (440a), and receiving device 130b reserves BEEP Channel 4 (440b). In this regard, both Channels 3 and 4 (440a, 440b) are provided with a profile adapted to manage the transfer of image data using JPIP. The receiving devices 130a, 130b use the dedicated BEEP channels 440a, 440b to request the transfer of image data with parameters specified for the requesting receiving device 130a, 130b (lines 146a, 146b, respectively). Thus, each receiving device 130a, 130b can request image data with specific resolution, size, location, component, layer, and other JPEG 2000 parameters.

In response to the requests (lines 146a, 146b), the image data server 120 transfers image data using JPIP to each receiving device 130a, 130b using its respective dedicated BEEP channel 440a, 440b, corresponding to the specified parameters.

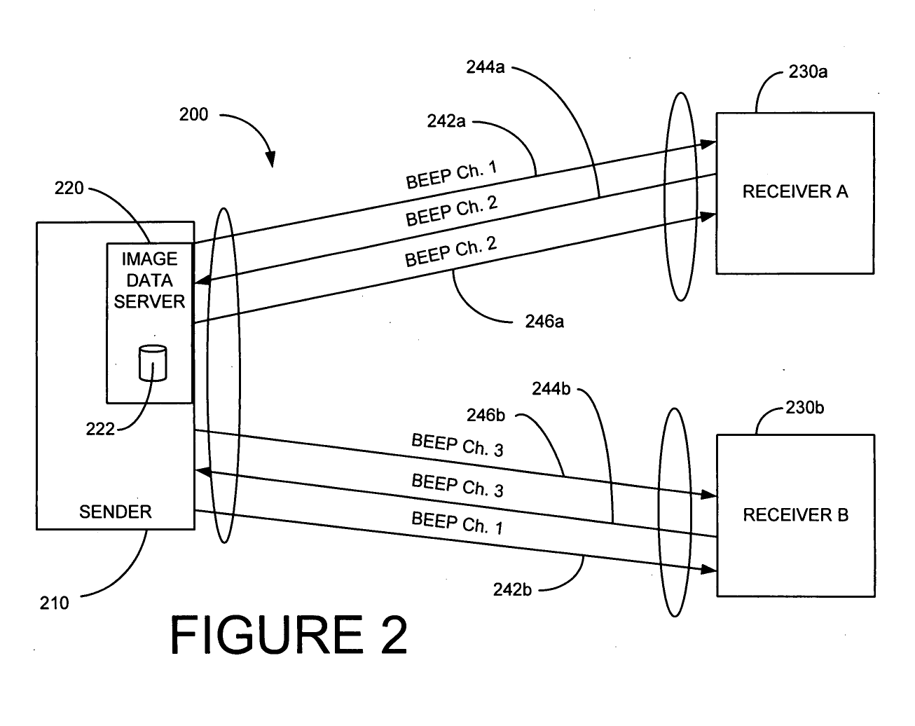

In other embodiments, the image data server may be integral with the sending device. One such embodiment is illustrated in FIG. 2. In this arrangement, a sending device 210 has an image data server 220 integrated therein. A data storage device, such as a database 222 is provided within the sending device 210 for access by the image data server 220. Receiving devices 230a, 230b are adapted to communicate with the sending device 210 and its integrated image data server 220. Thus, the sending device 210 may establish an SIP session with a BEEP session therein, as described above. Then, the sending device 210 transmits a notification of new image data to selected receiving devices 230a, 230b through a common channel (BEEP Channel 1) having a profile adapted to manage the notification (lines 242a, 242b). The receiving devices 230a, 230b reserve a different dedicated BEEP channel (channel 2 for receiving device 230a, and channel 3 for receiving device 230b) for transfer of JPEG 2000 image data with specified parameters (lines 244a, 244b). The sending device 210 then transmits the image data using JPIP through the dedicated BEEP channels to each requesting receiving device 230a, 230b (lines 246a, 246b).

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

1. A method of transferring image data, comprising:
establishing a communication session between a sending device and one or more receiving devices;
opening a common channel for transmission by said sending device of a notification of availability of image data; and
opening one or more data channels for transmission of at least a portion of said image data to said receiving devices, each data channel being dedicated to one of said receiving devices.

2. The method of claim 1, wherein said step of establishing a communication session includes establishing a session using Session Initiation Protocol (SIP).

3. The method of claim 2, wherein said step of establishing a communication session includes indicating use of Blocks Extensible Exchange Protocol (BEEP) to exchange image data in JPEG2000 Interactive Protocol (JPIP).

4. The method of claim 3, wherein said common channel and said data channels are BEEP channels.

5. The method of claim 1, wherein said step of establishing a communication session includes indicating use of Blocks Extensible Exchange Protocol (BEEP) to exchange image data in JPEG2000 Interactive Protocol (JPIP).

6. The method of claim 5, wherein said common channel and said data channels are BEEP channels.

7. The method of claim 1, further comprising:
receiving a request from each of said receiving devices for a dedicated data channel prior to said step of opening one-or more data channels.

8. The method of claim 7, wherein said request from each of said receiving devices includes specification of parameters relating to image data to be transferred to said receiving device.

9. The method of claim 8, further comprising:
transmitting image data to each of said receiving devices in accordance with parameters specified by each receiving device.

10. The method of claim 1, further comprising:
transmitting image data to each of said receiving devices in accordance with parameters specified by each receiving device.

11. The method of claim 1, wherein said sending device includes an image data server.

12. The method of claim 1, wherein at least one of said sending device and said receiving devices is a wireless device.

13. A program product, comprising machine readable program code for causing a machine to perform the following method steps:
establishing a communication session between a sending device and one or more receiving devices;
opening a common channel for transmission by said sending device of a notification of availability of image data; and
opening one or more data channels for transmission of at least a portion of said image data to said receiving devices, each data channel being dedicated to one of said receiving devices.

14. The program product of claim 13, wherein said method step of establishing a communication session includes establishing a session using Session Initiation Protocol (SIP).

15. The program product of claim 14, wherein said method step of establishing a communication session includes indicating use of Blocks Extensible Exchange Protocol (BEEP) to exchange image data in JPEG2000 Interactive Protocol (JPIP).

16. The program product of claim 15, wherein said common channel and said data channels are BEEP channels.

17. The program product of claim 13, wherein said method step of establishing a communication session includes indicating use of Blocks Extensible Exchange Protocol (BEEP) to exchange image data in JPEG2000 Interactive Protocol (JPIP).

18. The program product of claim 17, wherein said common channel and said data channels are BEEP channels.

19. The program product of claim 13, further comprising machine readable program code for causing a machine to perform the following method step:
receiving a request from each of said receiving devices for a dedicated data channel prior to said method step of opening one or more data channels.

20. The program product of claim 19, wherein said request from each of said receiving devices includes specification of parameters relating to image data to be transferred to said receiving device.

21. The program product of claim 20, further comprising machine readable program code for causing a machine to perform the following method step:
transmitting image data to each of said receiving devices in accordance with parameters specified by each receiving device.

22. The program product of claim 13, further comprising machine readable program code for causing a machine to perform the following method step:
transmitting image data to each of said receiving devices in accordance with parameters specified by each receiving device.

23. The program product of claim 13, wherein said sending device includes an image data server.

24. The program product of claim 13, wherein at least one of said sending device and said receiving devices is a wireless device.

25. A method of transferring image data, comprising:
establishing an SIP session between a sending device and at least one receiving device; and
initiating an image transfer session using BEEP channels within said SIP session, said image transfer including transfer of JPIP image data.

26. A program product, comprising machine readable program code for causing a machine to perform the following method steps:
establishing an SIP session between a sending device and at least one receiving device; and
initiating an image transfer session using BEEP channels within said SIP session, said image transfer including transfer of JPIP image data.

27. A system for transferring image data, comprising:
a sending device adapted to establishing a communication session with one or more receiving devices; and
an image data server adapted to respond to requests for image data from said one or more receiving devices;
wherein at least one of said sending device and said image data server is adapted to open one or more data channels for transmission of image data to said receiving devices, each data channel being dedicated to one of said receiving devices.

28. The system of claim 27, wherein said communication session is a Session Initiation Protocol (SIP) session.

29. The system of claim 28, wherein said sending device is adapted to indicate use of Blocks Extensible Exchange Protocol (BEEP) to exchange image data in JPEG2000 Interactive Protocol (JPIP) when establishing said communication session.

30. The system of claim 29, wherein said common channel and said data channels are BEEP channels.

31. The system of claim 27, wherein said sending device is adapted to indicate use of Blocks Extensible Exchange Protocol (BEEP) to exchange image data in JPEG2000 Interactive Protocol (JPIP) when establishing said communication session.

32. The system of claim 31, wherein said common channel and said data channels are BEEP channels.

33. The system of claim 27, wherein at least one of said sending device and said image data server is adapted to receive a request from each of said receiving devices for a dedicated data channel.

34. The system of claim 33, wherein said request from each of said receiving devices includes specification of parameters relating to image data to be transferred to said receiving device.

35. The system of claim 34, wherein said image data server is adapted to transmit image data to each of said receiving devices in accordance with parameters specified by each receiving device.

36. The system of claim 27, wherein said image data server is adapted to transmit image data to each of said receiving devices in accordance with parameters specified by each receiving device.

37. The system of claim 27, wherein said image data server is integral with said sending device.

38. The system of claim 27, wherein at least one of said sending device and said receiving devices is a wireless device.
